(19) United States
(12) Patent Application Publication
(10) Pub. No.: US 2003/0206994 A1
(43) Pub. Date: Nov. 6, 2003

(54) Microwave baking additive

(75) Inventor: Michael Jahnke, Burnsville, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Brechet & Richter Company, Minneapolis, MN

(21) Appl. No.: 10/465,833

(22) Filed: Jun. 16, 2003

Related U.S. Application Data
(63) Continuation-in-part of application No. 09/753,485, filed on Jan. 3, 2001, now Pat. No. 6,579,546.

(51) Int. Cl. A21D 2/00

(52) U.S. Cl. 426/19

(57) ABSTRACT

The present invention includes a microwave baking additive that has a gelling component, a gum component and an enzyme component. The present invention also includes a method of controlling moisture migration and starch recrystallization in microwavable bakery products. The present invention further includes a method of microwave baking a frozen bakery product to form a bakery product that is similar in appearance and texture to a bakery product that has been prepared using a conventional oven.

### CROSS-REFERENCE TO RELATED APPLICATION(S)

This application is a continuation-in-part of application Ser. No. 09/753,485 filed on Jan. 3, 2001.

### BACKGROUND OF THE INVENTION

During the last decade, a dramatic change in consumer eating patterns has emerged. Longer working hours, changing family structures and the pursuit of a healthier lifestyle are all factors that have influenced food purchasing decisions. As a result, the use of microwaves in food preparation has increased to meet consumer demand for food products that taste fresh and require minimal preparation time.

Unfortunately, there are several challenges in the use of microwave to prepare bakery products. For example, bakery products undergo rapid staling and toughening during application of microwave energy which changes the palatability of the bakery product. Furthermore, application of microwave energy to prepare or complete preparation of bakery products typically does not result in production of a bakery product that has the same appearance as a bakery product that has been baked using a conventional oven.

Even more challenging for bakers and food manufacturers is to produce a bakery product from a frozen bakery dough or a pre-baked frozen product that is subsequently baked using microwave energy to form a baked good that matches both the appearance and texture of a bakery product prepared using a conventional oven. Transforming a frozen bakery dough or a pre-baked frozen product into a baked good using microwave energy is often met with minimal success since microwave energy drives off needed moisture and is incapable of adequately browning the bakery dough or frozen product in a manner that typically occurs during conventional baking of frozen bakery dough. Therefore, many benefits of using microwave baking to prepare bakery products from frozen bakery dough, such as savings in preparation time and/or labor costs remains elusive.

### BRIEF SUMMARY OF THE INVENTION

The present invention includes a microwave baking additive that has a gelling component, a gum component and an enzyme component. The present invention also includes a method of controlling moisture migration and starch recrystallization in microwavable bakery products. The present invention further includes a method of microwave baking a frozen bakery product to form a bakery product that is similar in appearance and texture to a bakery product that has been prepared using a conventional oven.

### BRIEF DESCRIPTION OF THE DRAWINGS

FIG. 1 is a schematic of a process for producing a microwavable baking composition in accordance with the present invention.

FIG. 2 is another schematic for producing microwaved bakery products in accordance with the present invention.

### DETAILED DESCRIPTION

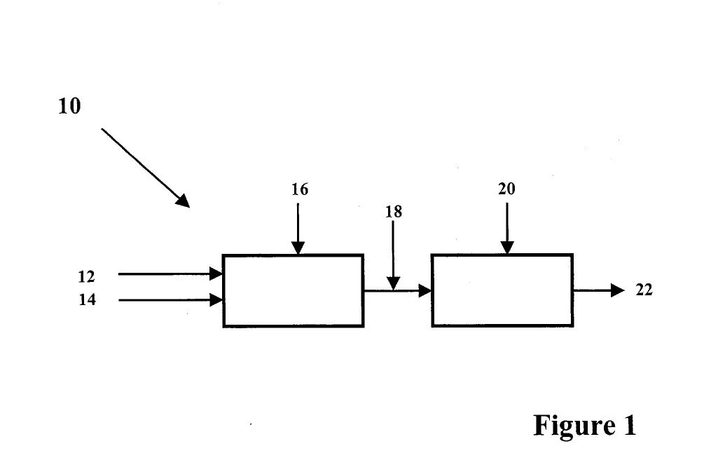

A process for producing a microwavable baking composition in accordance with the present invention is generally depicted at 10 in FIG. 1. In the process 10, a microwave baking additive 12 and a baking composition 14 are introduced into a mixing apparatus 16 to homogeneously blend the microwave baking additive 12 into the baking composition 14 and form a microwave baking composition 18.

Alternatively, one or more optional liquid components (not shown) may be introduced into the mixing apparatus 16 along with the microwave baking additive 12 and the baking composition 14. The mixing apparatus 16 transforms the microwave baking additive 12, the baking composition 14 and any optional liquid components into the microwave baking composition 18. Next, the microwave baking composition 18 is transferred from the mixing apparatus 16 into a freezing apparatus 20 that freezes the microwave baking composition 18 and forms a microwavable baking composition 22.

As disclosed in application Ser. No. 09/753,485 which is incorporated herein by reference, it has been discovered that incorporating a microwave baking additive that includes a gelling component, a gum component and an enzyme component into a baking composition in accordance with the present invention produces a microwavable baking composition that can be baked by application of microwave energy to form a microwaved bakery product having the same texture and appearance as a conventional oven-baked bakery product.

Baking a raw, frozen, par-baked frozen or conventional oven-baked bakery product through application of microwave energy typically results in rapid toughening of the bakery product. Such rapid toughening may be related to uneven moisture migration and moisture removal that occurs during or after application of microwave energy. Rapid toughening of bakery products during and after microwave baking may also be the result of starch recrystalization.

While not wanting to be bound to theory, it is believed that addition of the microwave baking additive to the baking composition in accordance with the present invention may facilitate formation of one or more structures when the gelling component gels the gum component in the microwave baking composition 18. These structures are believed capable of binding water, and preventing and controlling moisture migration and/or starch recrystalization both during or after application of microwave energy.

As disclosed in application Ser. No. 09/753,485, the gelling component may be generally blended into the microwave baking additive 12, the baking composition 14, the microwave baking composition 18, or the microwavable baking composition 22 as a liquid, vapor, or in granular form. By “gelling component” is meant one or more ions that form one or more cross-links to gel the gum component in less than about 60 seconds at a room temperature of about 70° F. Preferably, the gelling component includes one or more calcium ions that are capable of forming one or more cross-links with the gum component.

Still more preferably, the gelling component includes calcium ions that are capable of forming one or more cross-links that gel the gum component in less than about 60 seconds at a room temperature of about 70° F. More preferably, the gelling component includes calcium ions that are capable of forming one or more cross-links that gel the gum component in less than 30 seconds at a room temperature of about 70° F. Most preferably, the gelling component includes calcium ions that gels the gum component in less than about 15 seconds at a room temperature of about 70° F.

The gelling component, such as the preferred gelling component that includes calcium ions may be supplied as individual calcium salts, or supplied in various prepared mixtures of two or more calcium salts that are subsequently combined to form the gelling component. Some non-exhaustive examples of calcium salts include calcium acetate, calcium citrate, calcium gluconate, calcium glycerol phosphate mono-calcium phosphate, mono-calcium phosphate anhydrous, di- and tri-calcium phosphate, calcium sulfate, calcium carbonate, calcium lactate, calcium phosphite or any combination of any of these. Preferably the gelling component of the present invention is calcium acetate. Calcium acetate may be obtained from Ashland Chemical Company of Columbus, Ohio, Merck Company of Whitehouse Station, N.J. or American International Chemical, Inc., of Natick, Mass.

Though descriptions of the present invention are primarily made in terms of the preferred gelling component that includes calcium ions, it is to be understood that any other gelling component, such as ions of sodium, potassium, lithium, magnesium, manganese, iron, cobalt, nickel, copper, zinc, phosphorous, molybdenum, chromium, tin, vanadium, selenium, silicon, other charged ions, or any combination of any of these, may be substituted in place of the calcium ions in accordance with the present invention while still realizing benefits of the present invention. Likewise, it is to be understood that any combination of any calcium ion and any other gelling component may be used in accordance with the present invention, while still realizing the benefits of the present invention.

Additionally, the gelling component that is used in accordance with the present invention is an amount that is effective in forming one or more cross-links with the gum component. Furthermore, those of ordinary skill in the art will recognize that the amount of the gelling component may vary, depending upon the baking composition 14, or desired characteristics of the microwave baking composition 18 and microwavable baking composition 22. Consequently, the amount of the gelling component may be any amount that provides a necessary gel strength and/or gelling time to obtain desired characteristics of the microwave baking composition 18 or the microwavable baking composition 22.

The gum component may be blended into the microwave baking additive 12, the baking composition 14, the microwave baking composition 18 or the microwavable baking composition 22 as a liquid, vapor, spray or in granular form. By “gum component” is meant one or more polymers that forms a continuous three-dimensional molecular network that is capable of entrapping, binding or retaining one or more liquids.

The gum component that is used in accordance with the present invention is capable of being cross-linked by the gelling component. Preferably, the gum component is capable of being cross-linked to form a gel matrix that retains, entraps or binds one or more liquid components like water, milk, honey, syrups or any other liquid component typically included as part of the baking composition 14.

Furthermore, it is desirable for the gelling component and the gum component to bind and/or retain any liquid component at temperatures ranging from about −100° F. to about 500° F. A temperature range of about −100° F. to about 50° F. typically encompasses suitable freezing and/or refrigerator conditions that are used in accordance with the present invention while a temperature range of about 200° F. to about 500° F. encompasses suitable baking conditions used in accordance with the present invention.

The gum component of the microwave baking additive 12 may be included at an amount that is effective in (1) transforming a microwave baking composition 18 or microwavable baking composition 22 into a microwaved bakery product using microwave energy, or in controlling starch recrystallization or moisture migration when included as part of the microwave baking additive 12, the baking composition 14, the microwave baking composition 18, or the microwavable baking composition 22.

Furthermore, those of ordinary skill in the art will recognize that the amount of the gum component may be varied, depending upon the gelling component, the gum component, or the enzyme component selected, any other electrolytes, non-electrolytes, or other ingredients; ionic charge of the gum component, temperature, pH, particle size, molecular weight, water-holding capacity, and/or solvent requirements of the gum component; altitude, gel strength or the amount of time required to form the gel matrix.

Those of ordinary skill in the art may also vary the amount of gum component based upon desired characteristics of the baking composition 14, the microwave baking composition 18, or the microwavable baking composition 22. Therefore, the amount of the gum component may be any amount that provides the desired gel matrix.

The gum component of the present invention may include one or more gums that are capable of forming the desired gel matrix with the gelling component. Additionally, the gum component maybe supplied as individual gums or supplied in various prepared mixtures oftwo or more gums that are subsequently combined to form the gum component.

Some non-exhaustive examples of suitable gum components that may be used to practice the present invention include alginates, carrageenan, guar gum, locust bean gum, polysaccharides derived from Pseudomonas aeruginosa or Azotobacter vinelandii, starches like native starches, resistant starches, chemically- and/or physically-modified starches, converted starches, instant starches, high-amylose starches, high-amylopectin starches, waxy starches or any combination of any of these; fiber, protein, or any combination thereof.

Preferably, the gum component that is included as part of the microwave baking additive 12 is capable of forming a strong, thermal, irreversible gel when practicing the present invention. More preferably, the gum component of the microwave baking additive 12 includes one or more alginate gums that are capable of forming a strong, thermal, irreversible gel when combined with the gelling component.

Still more preferably, the gum component includes one or more alginate gums that are capable of being gelled with the preferred gelling component that includes calcium ions to form a strong, thermal irreversible gel in less than 30 seconds at a room temperature of about 70° F. Most preferably, the gum component includes one or more alginate gums that are capable of forming a strong, thermal irreversible gel with the gelling component that includes calcium ions in less than 15 seconds at a room temperature of about 70° F.

An alginate gum maybe characterized as a gum that includes alginic acid and may optionally include ions of sodium, potassium, other alkaline metals, other alkaline earth metals, ammonium, or any combination of any of these; polyvalent ions, such as ions of magnesium, calcium, manganese, iron, cobalt, nickel, copper, zinc, phosphorus, molybdenum, chromium, tin, vanadium, selenium, silicon, or any combination of any of these.

When the gelling component that includes calcium ions is combined with the gum component, the resulting gel maybe characterized as strong, tenuous, resistant to dissolution, thermal, irreversible or any combination of any of these. Preferably, combining the gelling component that includes calcium ions with the gum component that includes the alginate gum rapidly forms a gel that is described as strong, tenuous, resistant to dissolution, thermal, irreversible or any combination of any of these.

Furthermore, the gum component that includes one or more alginate gums, and therefore, the characteristics of the gel matrix derived from the gum component maybe adjusted based upon the ratio of monomeric units of the alginate gum(s), concentration, source, and degree of polymerization of alginic acid, pH and temperatures to obtain desired characteristics in the microwave baking composition 18, microwavable baking composition 22, or the microwaved bakery product.

The gum component of the microwave baking additive 12 may be supplied as a gum component that includes individual alginate gums or supplied in various prepared mixtures of two or more alginate gums that are subsequently combined to form the gum component. Some non-exhaustive examples of alginate gums that may be suitable for inclusion in the gum component include sodium alginate, ammonium alginate, sodium calcium alginate, calcium alginate, potassium alginate, esters of alginic acid like acetyl esters, ethyl esters, propyl esters, butyl esters, pentyl esters, hexyl esters, heptyl esters, octyl esters, nonyl esters, decyl esters, propyl glycerol alginate or any combination of any of these. As an example, sodium alginate that is available from Multi-Kem Corporation of Ridgefield, N.J. may be used as the gum component in accordance with the present invention.

While not wanting to be bound to theory, it is believed that the rapid formation of a strong, thermal irreversible gel matrix or network in the microwave baking composition 18 and the microwavable baking composition 22, is important in eliminating most, if not all microwave-induced toughening and firming of bakery products when baked using microwave energy. Current microwavable bakery goods typically include gum systems that merely bind water, enhance viscosity, or use gelled gums in which the gel matrix is broken or destroyed prior to inclusion into the baking dough and subsequent application of microwave energy results in microwave-induced toughening in the microwavable bakery goods. Indeed, current microwavable bakery goods rapidly toughen and firm up after application of microwave energy and do not form baked goods that resembles bakery products prepared using a conventional oven.

Though descriptions of the present invention are primarily made in terms of a gum that is capable of forming a gel matrix with a gelling component, it is to be understood that any other gum that forms a strong, thermal irreversible gel without a gelling component, such as carrageenan, guar gum, xanthan gum, locust bean gum, polysaccharides derived from Pseudomonas aeruginosa or Azotobacter vinelandii, starches like native starches, resistant starches, chemically- and/or physically-modified starches, converted starches, instant starches, high-amylose starches, high-amylopectin starches, waxy starches or any combination of any of these; fiber, protein, or any combination of any of these, may be substituted in place of the preferred gum component containing alginic acid gelled in the presence of the gelling component containing calcium ions, while still realizing the benefits of the present invention.

Likewise, it is to be understood that any combination of any gum that requires a gelling component and/or any gum component that does not require a gelling component that is capable of forming a strong, thermal irreversible gel may be used in accordance with the present invention to realize the benefits of the present invention.

As disclosed in application Ser. No. 09/753,485, the enzyme component may be blended into the microwave baking additive 12, the baking composition 14, or the microwave baking composition 18 as a liquid, vapor or in granular form. As used herein, an “enzyme” means any complex protein produced by a living cell that is capable of catalyzing a specific biochemical reaction on one or more target substrates. The term “enzyme” is also meant to encompass any complex protein capable of catalyzing the specific biochemical reaction in which the enzyme is substantially free of any microorganism. All references to “enzyme” is also understood as encompassing any synthetically-produced identical copy of the enzyme that is identical in molecular structure to the enzyme that originated in a living organism.

The enzyme component of the microwave baking additive 12 may be included at an amount that is effective in (1) transforming the microwave baking composition 18 or the microwavable baking composition 22 into a microwaved bakery product that resembles a bakery product prepared using a conventional oven, and (2) controlling starch recrystalization or moisture migration in the microwave baking composition 18, or the microwavable baking composition 22.

Furthermore, those of ordinary skill in the art will recognize that the amount of the enzyme component used in accordance with the present invention may be varied, depending upon the gelling component; the gum component; the baking composition 14; the conditions of the baking composition 14, such as the temperature, pH, or consistency; the liquid component; any optional additives; the particular enzymes employed; the activity of the enzymes; the amount of time required for catalysis; the desired characteristics of the microwavable baking composition 22, the microwaved bakery product, or any combination of any of these. Consequently, the process of the present invention is not limited to any particular level or amount of the enzyme component.

The enzyme component of the microwave baking additive 12 generally includes a carbohydrase. As used herein, a “carbohydrase” means an enzyme that is capable of hydrolyzing a glycoside linkage between a reducing functional group of a carbohydrate and a hydroxyl group of another molecule, such as another carbohydrate molecule, for example. Some non-exhaustive examples of carbohydrases that may be used in practicing the present invention include alpha-amylases; beta-amylases; amyloglucosidases; alpha-glucosidases; beta-glucosidases; pullalanases; dextranases; isoamylases; cellulases; hemicellulases, such as pentosonases or xylanases; or, any combination of any of these.

Preferably, the enzyme component of the present invention includes one or more enzymes that are capable of degrading and/or modifying one or more carbohydrates. Still more preferably, the enzyme component includes one or more xylanases that are capable of hydrolyzing non-starch polysaccharides, such as xylans, xylose-containing oligosaccharides, pentosans, or any combination of any of these. By “xylanase” is meant one or more enzymes that hydrolyze and/or modify xylans, xylose-containing oligosaccharides, pentosans or any combination of any of these.

The enzyme component, such as the enzyme component that includes xylanase may be supplied as individual enzymes or supplied in various prepared mixtures of two or more enzymes that are subsequently combined to form the enzyme component. As an example, xylanases may be obtained from Novo Nordisk Biochem of North America located in Franklinton, N.C. or Amano Enzyme U.S.A. Co., Ltd., of Lombard, Ill. Alternatively, the enzyme component may be supplied as a naturally occurring and/or an added part of any component of the baking composition 14.

Though descriptions of the present invention are primarily made in terms of the preferred enzyme component that includes a xylanase, it is to be understood that any other enzyme that is capable of degrading and/or modifying any other component of the baking composition 14, the microwave baking composition 18, the microwavable baking composition 22, such as alpha-amylases, beta-amylases, amyloglucosidases, alpha-glucosidases, beta-glucosidases, pullalanases, dextranases, isoamylases, cellulases, acid proteases, aminopeptidases, carboxypeptidases, sulfhydryl proteases, alkaline proteases, serine proteases, neutral proteases, endo or exo-proteases, lipoxygenases or lipases may be substituted in place of the xylanase while still realizing the benefits of the present invention. Likewise, it is to be understood that any combination of a xylanase enzyme and any other enzyme may be used in accordance with the present invention, while still realizing the benefits of the present invention.

The microwave baking additive 12 may be based on a concentrate or as part of a composition. The microwave baking additive concentrate, hereinafter referred to as “the additive concentrate” generally includes the gelling component, the gum component, the enzyme component, or any combination of any of these. An example of component concentration ranges for a preferred formulation of the additive concentrate is presented in Table 1 below:

TABLE 1

| COMPONENTS | CONCENTRATION (weight percent)* | |
|---|---|---|
| Gelling Component | about 30 to | about 50 |
| Gum Component | about 45 to | about 65 |
| Enzyme Component | less than | about 10 |

*Based on the total dry weight of the microwave baking additive concentrate.

The microwave baking additive 12 may also be based on a microwave baking additive composition, hereinafter referred to as the “additive composition.” The benefits of delivering the microwave baking additive 12 as part of an additive composition includes savings in preparation time and/or labor costs during production, rapid and/or consistent preparation of a variety of bakery products, reduced inventory costs, rapid and/or consistent baking of frozen microwaved bakery products via application of microwave to form a microwaved bakery product having the same texture and appearance of conventional oven-baked bakery products. Alternatively, the additive composition that does not include the microwave baking additive 12 may be included either before or after the microwave baking additive 12 is added when practicing the present invention.

The additive composition may be blended into the baking composition 14, the microwave baking composition 18, the microwavable baking composition 22 as a liquid, vapor, spray or in granular form. The additive composition may be included at an amount that is effective in transforming the microwave baking composition 18 or the microwavable baking composition 22 into a microwaved bakery product having the same texture as a baked good that has been prepared using a conventional oven. Furthermore, those of ordinary skill in the art will recognize that the amount of the additive composition may be varied depending upon each component of the additive composition, the baking composition 14, the microwave baking composition 18, the microwavable baking composition 22, mixing conditions, pH, temperature, or consistency in the baking composition 14, the microwave baking composition 18, the microwavable baking composition 22, or any combination of any of these. Consequently, the process of the present invention is not limited to any particular level of amount of the additive composition.

The additive composition may optionally include a flour portion, a non-starch polysaccharide portion, a fat portion, a protein portion, optional additives, or any combination of any of these, in combination with the gelling component, the gum component, and the enzyme component. The portions of the additive composition may be supplied as individual components, or supplied in various prepared mixtures of two or more components, that are subsequently combined to form the additive composition.

Some non-exhaustive examples of suitable flours that may be included as part of the flour portion include malt flour, wheat flour, gluten, potato flour, cracked wheat, rye flour, buckwheat flour, triticale flour, rice flour, amaranth flour, whole wheat flour, bread flour, all-purpose flour, pastry flour, cake flour, instantized flour, soy flour, corn flour, or cornmeal, or any combination of any of these.

Some non-exhaustive examples of non-starch polysaccharides that may be included as part of the non-starch polysaccharide portion include the above-mentioned xylans, xylose-containing oligosaccharides, or pentosans; cellobiose, cellulose, or any combination thereof. As used herein, the term “xylans” refers to complex carbohydrate polymers built from one or more D-xylose monomers. Furthermore, the term “pentosans” refers to any group of carbohydrates found with cellulose in plants that typically yield pentoses or 5-carbon sugars on hydrolysis. In addition, the term “cellulose” refers to any complex polysaccharides built from cellobiose, or 4-0-β-D-glucopyranosyl-D-glucose subunits. As an example, the non-starch polysaccharide may include cellulose, such as cellulose that is available as Solka Floc®, from Fiber Sales & Development Corporation located in Urbana, Ohio or as Cellogen®, from Multi-Kem Corporation of Ridgefield, N.J.

Some non-exhaustive examples of fats that may be included as part of the fat portion include oils such as sunflower oil, soybean oil, cottonseed oil, peanut oil, corn oil, olive oil, palm oil, canola oil; shortening, such as margarine or Crisc™; lard, hydrogenated fats, butter, cocoa butter or synthetic fat substitutes, such as sucrose polyesters, or any combination of any of these.

Some non-exhaustive examples of suitable protein that may be incorporated in the additive composition include eggs or portions thereof, such as frozen eggs, liquid eggs, egg yolks, whole eggs, egg whites, dried eggs, pasteurized eggs, imitation eggs that are made from milk solids or soy protein, or any combination thereof; dairy proteins, such as whey, whey protein, whey protein concentrate, whey permeate, de-lactosed whey, or casein; fish meal, such as fish protein meals; animal fluids, such as blood; microbial biomass, such as single-cell protein; soy protein flour, soy protein isolates, soy protein concentrates, rapeseed protein flour, sunflower protein flour, wheat protein flour, peanut protein flour; vegetable protein flour such as potato protein flour; and any of these in any combination. As an example, soy protein isolate that is available from Protein Technologies, Inc. of St. Louis, Miss. may be included as part of the additive composition.

Some non-exhaustive examples of suitable optional additives that may be used when practicing the present invention include emulsifiers such as mono- and di-glycerides; saturated mono and di-glycerides; sodium- and calcium stearoyl lactylate (SSL and CSL); ethoxylated mono- and di-glycerides (EMG); polysorbates (PS); lecithin; succinylated monoglycerides (SMG); diacetyl tartaric acid esters of mono-glycerides (DATEM); lactic acid esters, propylene glycol esters; polyglycerol esters; polyglycerol; stabilizers; sweeteners, such as fructose, glucose, invert sugar like Drivert, sucrose, corn syrup, high fructose corn syrup; acidulants, such as lactic acid, acetic acid, citric acid, malic acid or any combination of any of these. In addition, flavoring agents, such as vanilla, almond, cinnamon, nutmeg, spices, herbs, savory or fruity flavors; salt or salt buffers; or any combination of any of these, may also be used to flavor the baking composition 14.

An example of component concentration ranges for a preferred formulation of a microwave baking additive composition is presented in Table 2 below:

TABLE 2

| | CONCENTRATION | |
|---|---|---|
| COMPONENT | (weight percent)* | |
| Gelling component | about 1 | to about 75 |
| Gum component | about 1 | to about 75 |
| Enzyme component | about 10⁻⁶ | to about 25 |
| Flour portion | 0 | to about 40 |
| Non-starch polysaccharide portion | 0 | to about 25 |
| Fat portion | 0 | to about 25 |
| Protein portion | 0 | to about 40 |
| Optional additives | 0 | to about 90 |

*Based on the total dry weight of the additive composition.

The baking composition 14 generally includes a flour component, a liquid component, a leavening component, a fat component, a protein component, a sweetner component and optional additives. Some non-exhaustive examples of suitable flours that may be included as part of the flour component of the baking composition 14 include the flours listed above as suitable for the additive composition. Similarly, some non-exhaustive examples of liquids that may be included as part of the liquid component of the baking composition 14 include water, evaporated milk, skim milk, whole milk, soured milk, buttermilk, fruit juice, fruit pulp, honey, high fructose corn syrup, corn syrup, maple syrup, any liquid portion of the microwave baking additive 12 or any combination of any of these.

The leavening component that is included as part of the baking composition 14 is typically in the form of a physical, biological or chemical leavening agent or any combination of a physical, biological or chemical leavening agent. As disclosed in application Ser. No. 09/753,485, yeast compositions, baking soda, baking powder, air, steam, carbon dioxide, ethanol, nitrogen gas, oxygen gases, any other food grade gas, or any combination of any of these may be included as part of the baking composition 14 to leaven the baking composition 14.

Air, steam, carbon dioxide, nitrogen gas, oxygen gas, or any other food grade gas are examples of suitable physical leavening agents that may be used to leaven the baking composition 14 when practicing the present invention. Some non-exhaustive examples of baking compositions 14 that use physical leavening agents to leaven the baking composition include popovers, spoonbread, corn bread, johnnycake, timbales, cream puffs, pastries, or pie crusts.

To some degree, all baking compositions depend on air for leavening, but when air is insufficient to attain desired characteristics of the bakery products, other leavening agents like biological and/or chemical leavening agents are added to the baking composition 14. For example, yeast-leavened bakery products typically include a yeast component which is a biological leavening agent, as disclosed in application Ser. No. 09/753,485. Suitable examples of baking compositions that use yeast as the biological leavening agent include coffee cakes, sweet rolls like cinnamon rolls, raised donuts, stollens, Swedish tea rings, Sally Lunn, breads like Italian and French breads, bagels, pizzas, English muffins or the like. Furthermore, cinnamon rolls are an example of baking compositions that may include both biological and chemical leavening agents. For example, as disclosed in application Ser. No. 09/753,485, yeast, baking soda and baking powder were used to leaven microwavable cinnamon rolls in accordance with the present invention.

Similarly, baking soda, baking powders that include baking soda and/or acids/acids salts like cream of tartar, tartaric acid, monocalcium phosphate monohydrate, the anhydrous form of monocalcium phosphate, sodium aluminum sulfate, sodium acid pyrophosphate, sodium aluminum phosphate, dicalcium phosphate dihydrate, glucono-delta-lactone, ammonium bicarbonate, ammonium carbonate, any other single-acting baking powders, any other double-acting baking powders, or any combination of these are non-exhaustive examples of suitable chemical leavening agents that may be used in accordance with the present invention. Some non-exhaustive examples of baking compositions that include chemical leavening agents are popovers, fritters, griddle cakes, waffles, muffins, quick loaves, biscuits, pastry, creampuffs, matzoh, tortillas, muffins, shortcake, dumplings, spoon bread, biscuit, pastries, rolled cookies, drop cookies, bars, muffins, cakes, crackers, any other quick breads or the like.

Some non-exhaustive examples of suitable fats that may be included as part the baking composition 14 include the fats listed above as suitable for inclusion as part of the fat portion of the additive composition. Similarly, some non-exhaustive examples of suitable protein that may be included as part of the baking composition 14 include the protein listed above as suitable for inclusion as part of the protein portion of the additive composition.

Some non-exhaustive examples of suitable sweetners that may be used to sweeten the baking composition 14 include powdered sugar, raw sugar, turbinado sugar, brown sugar, glucose, maltose, lactose, invert sugar, sugar syrup, such as molasses, maple syrup, honey, corn syrup, high-fructose corn syrup, granulated sugar or any combination thereof. In addition, a non-nutritive sweetener, such as aspartame or saccharin, may also be included as part of the sweetener component in accordance with the present invention. The sweetener component may be supplied as individual sweeteners or supplied in various preparations of two more sweeteners that are subsequently combined to form the sweetener component.

The baking composition 14 may optionally include coloring agents, such as rapid browning agents like Maillose® that is available from Red Arrow Products Co., LLC., of Manitowoc, Wis. to promote the desired degree of browning in the microwaved bakery product to match the baked color of bakery products prepared using conventional ovens. Preferably, rapid browning agents are added to attain desired color characteristics of the microwaved bakery product when practicing the present invention. As an example, a 30% solution of Maillose® that is available from Red Arrow Products Co., LLC., of Manitowoc, Wis. may be sprayed onto a cinnamon roll that is prepared in accordance with the present invention in order to match the color of a conventional-oven baked cinnamon roll.

Additionally, those or ordinary skill in the art will recognize that the amount of each component of the baking composition 14, and therefore, the amount of the baking composition 14 may vary depending upon each component of the baking composition 14, the microwave baking additive 12, the microwave baking composition 18, the microwavable baking composition 22, the mixing apparatus conditions like temperature or humidity; pH, temperatures, desired elasticity, extensibility or consistency of the microwave baking composition 18; the microwaved bakery product, or any combination of any of these. Consequently, the process of the present invention is not limited to any particular level of amount of each component of the baking composition 14, nor an amount of the baking composition 14.

The baking composition 14 may be in the form of a dough composition or a batter composition depending on the level of liquid used to prepare the baking composition 14. Batter compositions are typically flour-based compositions that contain enough liquid to be beaten or stirred. Batter compositions can be subdivided into pour batters and drop batters. As an example, a pour batter generally has a liquid:flour ratio of about ⅔-1:1 while a drop batter generally has a liquid:flour ratio of about 1:2. Some non-exhaustive examples of products prepared from pour batters include popovers, timbales, griddle cakes, waffles, and the like while some non-exhaustive examples of products prepared from drop batters include cakes, muffins, drop cookies, cream puffs and the like.

Dough compositions are flour-based compositions that generally have less liquid in proportion to flour than that which is present in a batter composition and has a consistency that permits handling or kneading. Dough compositions may be subdivided into soft dough compositions in which the liquid:flour ratio is about 1:3 or a stiff dough that has a liquid:flour ratio of about 1:6 to about 1:8. Some non-exhaustive examples of products prepared from soft dough compositions include biscuits, yeast breads, rolls, sweet rolls or the like while some non-exhaustive examples of products prepared from stiff dough compositions include pastry, rolled cookies or the like.

Consequently, examples of baking compositions in the form of an unleavened dough composition include pie crusts or pop tarts. Similarly, examples of baking compositions in the form of chemically-leavened dough compositions include biscuits, pastries, or rolled cookies. Likewise, examples of chemically-leavened batter compositions include drop cookies, bars, muffins, or cakes. Additionally, examples of yeast-leavened baking compositions include french toast, breads, cinnamon rolls, or pizzas. It is envisioned that the microwave baking additive 12 can be mixed with any form of the baking composition 14 to attain microwave or microwavable baking compositions that can be subsequently microwaved without undergoing any toughening to resemble baked products prepared from conventional ovens.

The microwave baking additive 12, the baking composition 14 and optional liquid components are homogeneously blended in the mixing apparatus 16. Preferably, the mixing apparatus 16 that is used to practice the present invention is effective (1) to mix, stir, cream, beat, cut in, fold in, knead, mechanically-handle, or manipulate the microwave baking additive 12, the baking composition 14 and any optional liquid components to form the microwave baking composition 18, (2) to facilitate hydration of each component of the microwave baking composition 18, (3) to develop the desired structure of the microwave baking composition 18, (4) to develop the desired gel matrix, or (5) to incorporate air or any food grade gas into the microwave baking composition 18.

Furthermore, those of ordinary skill in the art will recognize that the amount of time and degree of agitation that is used to form the microwave baking composition 18 in accordance with the present invention may vary depending the microwave baking additive 12, the baking composition 14, the microwave baking composition 18, the microwavable baking composition 22, or the microwaved bakery product. As a result, the amount of time and degree of agitation is not limited to any particular level. A suitable example of a mixing apparatus that may be used to practice the present invention is the HF 190 Spiral Mixer that is available from Hobart Corporation of Toledo, Ohio.

After mixing, the microwave baking composition 18 is transferred to the freezing apparatus 20. In general, any conventional apparatus that is suitable for use in freezing may be used to freeze the microwave baking composition 18. While the type of freezing apparatus 20 is not critical to the present invention, the freezing apparatus 20 preferably reduces the temperature of the microwave baking composition 18 to an internal temperature of about 0° F. to about minus 30° F. in less than about 2 hours. Freezing times higher than about 2 hours are less desirable because such longer freezing times may negatively impact the texture of the microwaved bakery product. Most preferably, the freezing apparatus 20 that is used to practice the present invention reduces the internal temperature of the microwave baking composition 18 to an internal temperature of less than about 0° F. in less than about 30 minutes. An example of a suitable freezing apparatus 128 is Model No. 1500 Flex Freezer which is available from C&R Refrigerator, Inc., of Center, Tex. Another example of a suitable freezing apparatus is Model No. FT-35 Blast Freezer that is available from Armfield Ltd., of Ringwood, England.

Alternatively, the internal temperature of the microwave baking composition 18 may also be reduced by using a refrigeration apparatus (not shown) singly or in combination with the freezing apparatus 20. The benefits of refrigerating the microwave baking composition 18 include minimizing capital or equipment costs to bakers and/or food manufacturers, minimizing any negative texture changes that occur when using the freezing apparatus 20, or promoting a slower degree of leavening activity that would otherwise be affected when placed in the freezing apparatus. In general, any conventional apparatus that is suitable for use in refrigerating a microwave baking composition may be used to reduce the internal temperature of the microwave baking composition 18 to about 25° F. to 50° F.

In an alternative embodiment, the microwave baking composition 18 may be allowed to leaven or ferment for a time and temperature that is effective to attain a desired grain and and/or crumb structure in the microwaved bakery product (not shown) prior to freezing in the freezing apparatus. The microwave baking composition 18 may be fermented during transport to, within and/or transport from a proofing apparatus (not shown) as disclosed in patent application Ser. No. 09/753,485.

Next, the microwavable baking composition 22 may undergo one or more processing steps to form microwaved bakery products having the same texture and appearance as bakery products baked using a conventional oven. For example, the microwavable baking composition 22 may be microwaved (not shown), packaged (not shown), oven-baked using a conventional oven or convection oven (not shown), finished (not shown), shaped (not shown), or any combination of any of these, as disclosed in patent application No. Ser. 09/753,485.

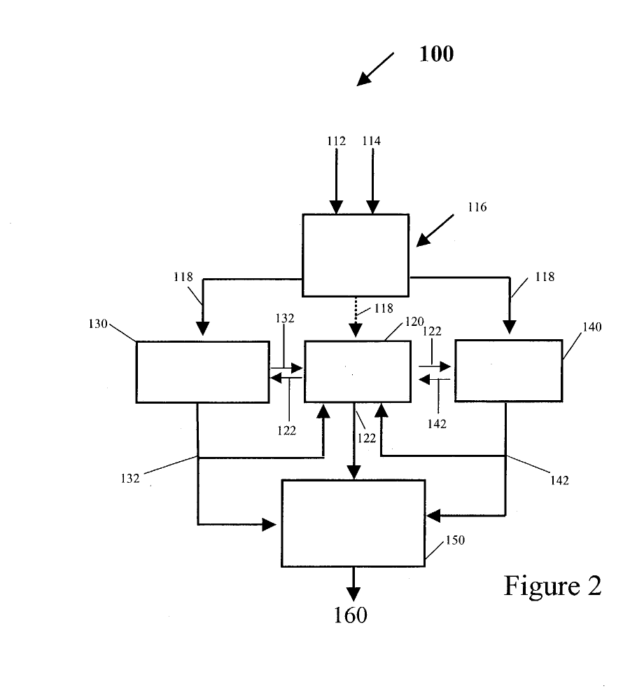

Alternatively, microwaved bakery products may be prepared in accordance with 100 depicted in FIG. 2. In 100, a microwave baking additive 112 and a baking composition 114 are mixed in a mixing apparatus 116 to form a microwave baking composition 118. After mixing, the microwave baking composition 118 may be transferred from the mixing apparatus 116 into a freezing apparatus 120 that freezes the microwave baking composition 118 and forms a microwavable baking composition 122.

Alternatively, the microwave baking composition 118 may be transferred into a conventional baking apparatus 130, such as a conventional oven or a convection oven that partially or fully bakes the microwave baking composition to form a baked microwave baking composition 132. In a different embodiment, the microwave baking composition 118 may be transferred into a packaging apparatus 140 that packages the microwave baking composition to form a packaged, microwave baking composition 142. Next, the baked, microwave baking composition 132 or the packaged, microwave baking composition 142 can be transferred into the freezing apparatus 120 that freezes the baked, microwave baking composition 132 and the packaged, microwave baking composition 142 to form a frozen, baked, microwavable baking composition (not shown) or frozen, packaged, microwavable baking composition (not shown) respectively.

After freezing, the microwavable baking composition 122 may be transferred to the conventional baking apparatus, such as a conventional oven or a convection oven that partially or fully bakes microwavable baking composition and forms a baked, microwavable baking composition (not shown). Similarly, the microwavable baking composition 122 may be transferred to the packaging apparatus 140 that packages the microwavable baking composition 122 and forms a packaged, microwavable baking composition (not shown).

Both the baked, microwave baking composition 132, the baked, microwavable baking composition (not shown) and the frozen, baked, microwavable baking composition (not shown) may be transferred to a microwaving apparatus 150 for microwaving to form microwaved bakery products 160 having the same or better texture and appearance as fresh-baked bakery goods prepared using a conventional oven.

For example, baked microwave or microwavable baking compositions in the form of baked biscuits containing the microwave baking additive, such as baked biscuits held at room temperature or frozen baked biscuits may be microwaved to warm the biscuits prior to consumption without undergoing any microwave-induced toughening or firming that typically occurs when microwaving baked or frozen baked biscuits. Such biscuits would prove beneficial to restaurants or food service institutions desiring to quickly warm up baked biscuits prior to serving to clients. Alternatively, the baked microwave or microwavable baking compositions maybe in the form of par-baked fresh or frozen deep dish pizzas that are microwaved to warm the deep dish pizzas prior to consumption.

Similarly, both the packaged, microwave baking composition 142, the packaged, microwavable baking composition (not shown), and the frozen, packaged, microwavable baking composition (not shown) may be microwaved in the microwaving apparatus 150 to form microwaved bakery products 160 having the same or better texture and appearance as fresh-baked bakery goods prepared using a conventional oven.

For example, packaged microwave or microwavable baking compositions in the form of nutritious breakfast sandwiches, such as individually packaged frozen or freshly prepared breakfast sandwiches may be microwaved to bake the breakfast sandwiches without undergoing any microwave-induced toughening that typically occurs when attempting to microwave bake breakfast sandwiches. Such breakfast sandwiches would also prove beneficial for meeting the needs of individuals and/or families desiring a rapidly prepared nutritious breakfast prior to starting the day. Alternatively, the packaged microwave or microwavable baking compositions may be in the form of fresh or frozen muffins or french toast that are transformed into portable breakfast meals after microwave baking the muffins or french toast.

After freezing, the microwavable baking composition 122 is transferred from the freezing apparatus to a microwave apparatus 150 to form a microwaved bakery product 160 having the same or better texture and appearance as fresh-baked bakery goods prepared using a conventional oven. The benefits of transforming a microwavable baking composition 122 through microwave energy into the microwaved bakery product 160 that is similar in texture and appearance to baked bakery goods prepared using conventional ovens include savings in preparation time and/or labor cost, rapid and consistent preparation of bakery products, extended product-shelf life or ease in serving. In fact, toughening, staling, warmed-over flavors and/or color variations that typically plague bakery products subjected to microwave baking are avoided, and preferably eliminated when practicing the present invention.

In general, any conventional microwaving apparatus 150 that is capable of generating microwave energy for cooking a food may be suitable for use in baking the microwave baking composition 18(118) or the microwavable baking composition 22(122) to generate microwaved bakery products 160 that are similar in texture and appearance to conventional-oven prepared bakery goods.

Preferably, the microwave energy that is used to bake the yeast-leavened microwavable dough 24 preferably is effective (1) to rapidly heat the microwave baking composition 18 (118) or the microwavable baking composition 22(122), (2) to not overheat the microwave baking composition 18(118) or the microwavable baking composition 22(122), or (3) to evenly heat the microwave baking composition 18(118) or the microwavable baking composition 22(122).

Furthermore, those of ordinary skill in the art will recognize that the microwave energy used for baking in accordance with the present invention may be varied, depending upon the microwave baking composition 18(118) or the microwavable baking composition 22(122), or the desired characteristics of the microwaved bakery products 160; the size or output power range of the microwaving apparatus 150, a location of the power output within the microwaving apparatus 150 or any devices that are used to uniformly distribute the power, such as mode stirrers, waveguides or turntables; duty cycles; any packaging material like susceptor plates; or any combination of any of these.

Consequently, the microwave energy that is used to bake the microwave baking composition 18(118) or the microwavable baking composition 22(122) maybe any combination of power output and time that provides the desired characteristics of the microwaved bakery product 160. As an example, generally shorter times and a lower power output are used to microwave bake the microwave baking composition 18(118) while longer times and a higher power output are used to bake the microwavable baking composition 22(122). A suitable example of a microwaving apparatus 34 is the 1000 watt Sanyo Microwave Super Show-Ware Microwave that is available from Sanyo North America Corporation in San Diego, Calif.

Some non-exhaustive examples of microwaved bakery products 160 that may microwaved without undergoing microwave induced toughening after adding the microwave baking additive 12 to the baking composition 14 include baking compositions in the form of popovers, timbales, griddle cakes, waffles, cakes, muffins, drop cookies, cream puffs, biscuits, yeast breads, rolls, sweet rolls, pastry, rolled cookies and the like.

The microwaved bakery products 160 that are prepared in accordance with the present invention yield a number of different benefits. For example, incorporating the microwave baking additive 12 in accordance with the present invention initially eliminates rapid toughening and/or staling that occurs during and/or after application of microwave energy when baking the baking compositions.

Furthermore, microwaved bakery products 160, like pizzas, cinnamon rolls, muffins, or biscuits that include the microwave baking additive 12 display little, if any textural variations like gumminess, toughness, chewiness even after about 30 minutes from the time of microwave baking. The elimination of most, if not all toughening and/or staling in microwaved bakery products 160 greatly increases profitability of these bakery products to the bakers and/or food manufacturers since bakers and/or food manufacturers would typically have to discard any microwaved bakery products once they become hard, tough, soggy or caused consumers to experience difficulty during consumption.

Bakers and/or food manufacturers alike may also benefit from an increase in tolerance of microwaved bakery products 160 baked by microwave energy due to the incorporation of the microwave baking additive 12 since microwaved bakery products 160 prepared in accordance with the present invention maintain the fresh-baked taste experience in which there is little, if any textural or color variations over a substantial amount of time, such as after more than about 30 minutes.

Additionally, when a microwaved bakery product 160 is prepared in accordance with the present invention, no other negative defects, such as large gaping holes in the crumb and/or crust, flavor variations, uneven color distribution and even warmed-over flavors that typically exist in microwaved bakery products 160 subjected to microwave baking are observed in the present invention. Furthermore, such negative defects are not observed even after a substantial time has elapsed.

Besides eliminating most, if not all textural variations in microwaved bakery products 160 that include the microwave baking additive 12, the process of the present invention also presents no unique handling adjustments, such as additional liquid requirements, a sticky dough consistency, non-homogenous blending of components or unique fermentation requirements.

Thus, several major beneficial aspects of the process of the present invention including eliminating most, if not all toughening and/or staling in microwaved bakery product during and/or after microwave baking, maintaining a fresh conventional oven-baked taste experience with substantially no textural variations over time, permitting additional microwaving of the microwaved bakery product 160 without any changes in texture, and reducing preparation time by microwave baking a microwaved bakery product with little, if any product differences between a bakery product prepared using a conventional oven or a convection oven and the microwaved bakery products 160 offer tremendous advantages to food manufacturers and/or bakers.

The present invention is more particularly described in the following examples that are intended as illustrations only since numerous modifications and variations within the scope of the present invention will be apparent to those skilled in the art.

### EXAMPLES

### Example 1

This example illustrates a method for producing microwavable muffins. The microwavable muffin serves as an example of a chemically-leavened batter composition that does not undergo microwave-induced toughening when the microwave baking additive is included as part of the chemically-leavened batter composition in accordance with the present invention. Initially, a microwave muffin base was prepared using the ingredients at the concentration presented in Table 3 below:

TABLE 3

| | INGREDIENT |
|---|---|
| | CONCENTRATION |
| INGREDIENT | (Weight Percent)* |
| Sugar | 45.20 |
| Cake Flour | 26.8168 |
| Bread Flour | 9.16 |
| Shortening | 6.10 |
| Soybean Oil | 0.52 |
| Lecithin | 0.30 |
| Nonfat Dry Milk | 5.20 |
| Polysorbate 60 | 0.10 |
| Sodium Stearoyl Lactylate | 0.05 |
| Salt | 0.70 |
| Xanthan gum | 0.15 |
| Baking Soda | 0.65 |
| Sodium acid pyrophosphate | 0.22 |
| Sodium aluminum phosphate | 0.50 |
| Anhydrous monocalcium phosphate | 0.22 |
| Wheat starch | 5.55 |
| Carboxymethylcellulose | 0.10 |
| Solka Floc ® | 0.21 |
| Sodium Alginate | 0.44 |
| Calcium Acetate | 0.33 |
| Soy Protein Isolate | 0.18 |
| Enzyme (Fungamyl Super MA) | 0.032 |

*based on the total weight of the microwave muffin base.

Next, about 5 lbs of the microwave muffin base, about 1 lb and 3 ounces of water, about 1 lb and 12 ounces of whole egg and about 1 lb and 8 ounces of soybean oil were mixed together to form a microwave muffin mix. After mixing the microwave muffin mix, about 3.5 ounces of microwave muffin mix was transferred into a paper muffin baking cup. Next, the microwave muffin mix was frozen in the paper muffin baking cup after being placed in a −6° F. freezer supplied by Traulsenn and Co., Inc. of College Point, N.Y.

After freezing, the frozen microwavable muffin was placed in a Sanyo Microwave Super Show-Ware 1000 watt microwave oven and microwave baked on “high” for about 90 seconds. Evaluations of the microwaved muffin indicated that the microwaved muffin was evenly baked, tender, had a uniform grain, and had no textural variations, such as gumminess, hardness, toughness or sogginess. In fact, the microwaved muffin was similar in taste, texture and appearance to oven-baked muffins. Rapid toughening and/or staling that typically occurs after microwave baking of muffins was not observed even after about 10 minutes. The muffin maintained a soft, tender, clean bite that also did not change after sitting.

### Example 2

This example illustrates a method for producing microwavable deep dish pizzas. The microwavable deep dish pizza serves as an example of a par-baked, yeast-leavened dough composition that does not undergo microwave-induced toughening when the microwave baking additive is included as part of the par-baked, yeast-leavened dough composition in accordance with the present invention. Initially, a microwave pizza concentrate was prepared using the ingredients at the concentrations presented in Table 4 below:

TABLE 4

| | INGREDIENT CONCENTRATION |
|---|---|
| INGREDIENTS | (WEIGHT PERCENT)* |
| Flour | 44.3427 |
| Dextrose (corn sugar) | 18.4865 |
| Granulated Salt | 12.2410 |
| Soybean salad oil | 0.4621 |
| Garlic Oleoresin | 0.0369 |
| L-cysteine (dough conditioner) | 0.0212 |
| Dough Additive | 12.1159 |
| Guar Gum | 5.9956 |
| No-Bro-Do Improver | 5.9965 |
| Enzyme (Fungamyl Super MA) | 0.3020 |

*based on the total weight of the microwave pizza concentrate

Next, about 4 lbs and 12 ounces of the microwave pizza concentrate, about 25 lbs of about 11.5% protein flour, about 9 ounces of salad oil, about 1 lb and 15 ounces of yeast, and about 16 lbs and 6 ounces of water were mixed for 1 minute on low speed of a Hobart mixer followed by 9 minutes on medium speed until the pizza dough composition was developed.

After mixing, the pizza dough composition was allowed to rest for 10 minutes. After resting, the pizza dough composition was divided, and then fermented for 15 minutes to leaven the pizza dough composition. After fermenting, the yeast-leavened dough composition was pressed (rolled out) in the form of a deep dish pizza and baked at 550° F. for 5 minutes to form a par-baked yeast-leavened pizza dough. After baking, the par-baked yeast-leavened pizza dough was frozen in a −6° F. freezer supplied by Traulsenn and Co., Inc. of College Point, N.Y.

After freezing, the frozen pizza dough was removed from the freezer and about 1 ounce of Contadina® pizza sauce was spread onto the frozen pizza dough. About 1 ounce of Crystal Farms Mozzarella Cheese of Minneapolis, Minn. was sprinkled onto the pizza sauce and four pieces of pepperoni supplied by Hormel Foods Corporation of Austin, Minn. was placed on top of the cheese. The frozen pizza dough along with the pizza sauce, cheese and pepperoni were placed in a Sanyo Microwave Super Show-Ware 1000 watt microwave oven and microwave baked on “high” for about 2 minutes.

The par-baked deep dish cheese and pepperoni pizza had no textural variations, such as gumminess, hardness, toughness or sogginess in the pizza crust. In fact, the pizza product maintained a uniformed texture in which there were no observable large, gaping holes that indicated improper fermentation. Rapid toughening and/or staling that typically occurs after microwave baking of pizzas was not observed even after about 30 minutes of the deep dish cheese and pepperoni pizza sitting on the table. The deep dish cheese and pepperoni pizza maintained a soft, chewy, clean bite that did not change during the entire one hour evaluation time period. Lastly, there were no discemable differences between a deep dish pizza prepared using a conventional oven and the microwaved par-baked deep dish cheese and pepperoni pizza of this example.

### Example 3

The following example compares different biscuit composition formulations. A control microwavable biscuit composition containing a gelling component (calcium acetate), a gum component (sodium alginate) and an enzyme component (xylanase was compared against a test biscuit composition containing sodium alginate and calcium acetate. There was no enzyme component added to the test biscuit composition. The following ingredients at the concentrations presented in Table 5 were mixed, scooped onto baking sheets, frozen in a frozen in a −6° F. freezer supplied by Traulsenn and Co., Inc. of College Point, N.Y. prior to microwaving for 90 seconds on high in a 1000 watt Sanyo Microwave Super Show-Ware microwave oven.

TABLE 5

| | INGREDIENT | INGREDIENT |
|---|---|---|
| | CONCENTRATION | CONCENTRATION |
| INGREDIENTS | (Weight Percent)* | (Weight Percent)* |
| Whey | 1.20 | 1.20 |
| Baking Soda | 0.60 | 0.60 |
| Granulated Salt | 0.85 | 0.85 |
| Dextrose (Corn sugar) | 1.20 | 1.20 |
| Granulated sugar | 0.60 | 0.60 |
| Sodium acid | 0.80 | 0.80 |
| pyrosphosphate | | |
| Flour | 39.238 | 39.238 |
| Shortening | 16.75 | 16.75 |
| Non fat dry milk | 2.50 | 2.50 |
| Mikro Fresh | 0.60 | 0.60 |
| Whey Protein | 1.80 | 1.80 |
| Concentrate | | |
| Solka Floc ® | 0.15 | 0.15 |
| Soy Protein Isolate | 0.12 | 0.12 |
| Carboxymethylcellulose | 0.07 | 0.07 |
| Sodium Alginate | 0.30 | 0.30 |
| Calcium Acetate | 0.22 | 0.22 |
| Enzyme (Fungamyl | 0.002 | 0 |
| Super MA) | | |
| Water | 33.00 | 33.00 |

After microwave baking, both the control and test microwave biscuit compositions were evaluated. The microwaved control biscuit composition was easier to cut, tender, moist, evenly baked, had a smooth compact exterior surface, and possessed a soft chew. The test biscuit composition, on the other hand, was much more difficult to cut, unevenly baked, tough, mealy, had a very rough exterior surface, and was tough to chew. Additionally, the test biscuit composition toughened up after microwaving.

### Example 4

This example illustrates the importance of incorporating a gum system that is characterized by formation of a strong, thermal irreversible gel in combination with an enzyme component. A control microwavable biscuit composition that contained a gelling component (calcium acetate), a gum component (sodium alginate) that is gelled by the gelling component and an enzyme component (xylanase) was compared against a test biscuit composition containing a gum system(calcium sulfate and sodium alginate) that does not form a strong, thermal irreversible gel and an enzyme component (xylanase). The following ingredients at the concentration presented in Table 6 were mixed, scooped onto baking sheets, frozen in a frozen in a −6° F. freezer supplied by Traulsenn and Co., Inc. of College Point, N.Y. prior to microwaving for 90 seconds on high in a 1000 watt Sanyo Microwave Super Show-Ware microwave oven. During scooping onto the baking sheet, the test baking composition was tacky and there was difficulty in releasing the test baking composition from the scoop.

TABLE 6

| | INGREDIENT | INGREDIENT |
|---|---|---|
| | CONCENTRATION | CONCENTRATION |
| INGREDIENTS | (Weight Percent)* | (Weight Percent)* |
| Whey | 1.20 | 1.20 |
| Baking Soda | 0.60 | 0.60 |
| Granulated Salt | 0.85 | 0.85 |
| Dextrose (Corn sugar) | 1.20 | 1.20 |
| Granulated sugar | 0.60 | 0.60 |
| Sodium acid | 0.80 | 0.80 |
| pyrosphosphate | | |
| Flour | 39.238 | 39.238 |
| Shortening | 16.75 | 16.75 |
| Non fat dry milk | 2.50 | 2.50 |
| Mikro Fresh | 0.60 | 0.60 |
| Whey Protein | 1.80 | 1.80 |
| Concentrate | | |
| Solka Floc ® | 0.15 | 0.15 |
| Soy Protein Isolate | 0.12 | 0.12 |
| Carboxymethylcellulose | 0.07 | 0.07 |
| Sodium Alginate | 0.30 | 0.30 |
| Calcium Sulfate | 0 | 0.22 |
| Calcium Acetate | 0.22 | 0 |
| Enzyme (Fungamyl | 0.002 | 0.002 |
| Super MA) | | |
| Water | 33.00 | 33.00 |

After microwave baking, both the control and test microwave biscuit compositions were evaluated. The microwaved control biscuit composition was easier to cut, tender, moist, evenly baked, had a smooth compact exterior surface, and possessed a soft chew. The test biscuit composition, on the other hand, was much more difficult to cut, tough, gummy, a viscous mass that contained moist spots, tough to break apart, had a very rough exterior surface, and was tough to chew. Additionally, the test biscuit composition toughened up after microwaving.

Although the present invention has been described with reference to preferred embodiments, workers skilled in the art will recognize that changes may be made in form and detail without departing from the spirit and scope of the invention.

1. A microwave baking additive comprising:
a gelling component, a gum component, and an enzyme component, wherein the gelling component is effective to gel the gum component and form an irreversible gel in a baking composition.

2. The microwave baking additive of claim 1 wherein the gelling component is calcium acetate.

3. The microwave baking additive of claim 1 wherein the gum component is sodium alginate.

4. The microwave baking additive of claim 1 wherein the enzyme component is a xylanase.

5. The microwave baking additive of claim 1 and further including a flour component, a non-starch polysaccharide component, a fat component, a protein component or any combination of any of these.

6. The microwave baking additive of claim 1 wherein the enzyme component is effective to degrade the flour component, the non-starch polysaccharide component, or any combination thereof.

7. A method of forming a microwave baking composition, the method comprising:
providing a microwave baking microwave baking additive, the microwave baking additive comprising a gelling component, a gum component, and an enzyme component; and
applying the microwave baking additive to a baking composition to form a microwave baking composition, wherein the gelling component is effective to gel the gum component in the microwave baking composition.

8. The method of claim 7 wherein the microwave baking composition comprises a chemical-leavening component.

9. The method of claim 7 wherein the microwave baking composition comprises a biological-leavening component.

10. The method of claim 7 wherein the microwave baking composition comprises a physical-leavening component.

11. The method of claim 7 wherein the microwave baking composition is a dough composition.

12. The method of claim 7 wherein the microwave baking composition is a batter composition.

13. A method of forming a bakery product comprising:
providing a microwave baking additive comprising a gelling component, a gum component and an enzyme component;
applying the microwave baking additive to a baking composition to form a microwave baking composition, wherein the gelling component is effective to gel the gum component in the microwave baking composition; and
microwaving the microwave baking composition to form a bakery product.

14. The method of claim 13 wherein the gelling component is calcium acetate.

15. The method of claim 13 wherein the gum component is sodium alginate.

16. The method of claim 13 wherein the enzyme component is a xylanase.

17. A method of forming a microwavable baking composition comprising:
blending a microwave baking additive comprising a gelling component, a gum component and an enzyme component with a baking composition to form a microwave baking composition, wherein the gelling component is effective to gel the gum component in the microwave baking composition; and
freezing the microwave baking composition to form the microwavable baking composition.

18. The method of claim 17 and further including baking the microwave baking composition to form a baked microwaved bakery product.

19. The method of claim 17 and further including microwaving the microwavable baking composition to form a microwaved bakery product.

20. A method of forming a microwave baking composition comprising:
blending a microwave baking additive comprising a gelling component, a gum component and an enzyme component with a baking composition to form a microwave baking composition, wherein the gelling component is effective to gel the gum component in the microwave baking composition.

21. The method of claim 20 and further including freezing the microwave baking composition to form a microwavable baking composition.

22. The method of 20 and further including microwaving the microwavable baking composition to form a microwaved bakery product.

23. The method of claim 20 and further including baking the microwave baking composition to form a baked microwave baking composition.

24. The method of claim 23 and further including freezing the baked microwave baking composition to form a frozen baked microwave baking composition.

25. The method of claim 24 and further including microwaving the frozen baked microwave baking composition to form a microwaved bakery product.

26. The method of claim 20 wherein the baking composition is an unleavened baking composition.

27. The method of claim 20 wherein the baking composition comprises a chemical-leavening component.

28. The method of claim 20 and further including packaging the microwave baking composition to form a packaged microwave baking composition.

29. The method of claim 28 and further including freezing the packaged microwave baking composition to form a frozen packaged microwave baking composition.

30. The method of claim 29 and further including microwaving the frozen packaged microwave baking composition to form a microwaved packaged bakery product.

31. A method of producing a bakery product, the method comprising:
freezing a microwavable baking composition comprising a baking composition, a gelling component, a gum component and an enzyme component, wherein the gelling component is effective to gel the gum component in the microwave baking composition prior to freezing; and
microwaving the microwavable baking composition to form the bakery product.

32. The method of claim 31 wherein the gelling component is calcium acetate.

33. The method of claim 31 wherein the gum component is sodium alginate.

34. The method of claim 31 wherein the enzyme component is a xylanase.

35. A microwave baking additive comprising:
a gum component capable of forming a strong, thermal irreversible gel and an enzyme component, and wherein the gum component is effective to control moisture migration, starch crystallization, or any combination of any of these.

36. A method of forming a microwavable baking composition comprising:
blending a microwave baking additive comprising a gum component and an enzyme component with a baking composition to form a microwave baking composition, wherein the gum component forms a thermal irreversible gel that effective to bind water, control moisture migration, or starch crystallization in the microwave baking composition; and
freezing the microwave baking composition to form the microwavable baking composition.
